(19) United States
(12) Patent Application Publication
(10) Pub. No.: US 2025/0061596 A1
(43) Pub. Date: Feb. 20, 2025

(54) LEARNING METHOD AND DEVICE FOR ESTIMATING DEPTH INFORMATION OF IMAGE

(71) Applicants: Electronics and Telecommunications Research Institute, Daejeon (KR); The Trustees of Indiana University, Bloomington, IN (US)

(72) Inventors: Soon-heung JUNG, Daejeon (KR); Vibhas Kumar VATS, Bloomington, IN (US); David J. CRANDALL, Bloomington, IN (US); MD Alimoor REZA, Bloomington, IN (US); Sripad JOSHI, Bloomington, IN (US)

(73) Assignees: Electronics and Telecommunications Research Institute, Daejeon (KR); The Trustees of Indiana University, Bloomington, IN (US)

(21) Appl. No.: 18/806,829

(22) Filed: Aug. 16, 2024

Related U.S. Application Data
(60) Provisional application No. 63/519,999, filed on Aug. 16, 2023.

(30) Foreign Application Priority Data
Aug. 9, 2024 (KR) 10-2024-0106892

(51) Int. Cl. G06T 7/55

(52) U.S. Cl. CPC G06T 7/55; G06T 2207/20081

(57) ABSTRACT

A training method and device for estimating depth information of an image are disclosed. The training method may include obtaining depth information of a first image according to a resolution based on the first image, and outputting a per-pixel depth error of the first image based on the depth information of the first image, depth information of a second image, and camera parameters.

### CROSS-REFERENCE TO RELATED APPLICATION

This application claims the benefit of U.S. Provisional Application No. 63/519,999 filed on Aug. 16, 2023, in the U.S. Patent and Trademark Office, and claims the benefit of Korean Patent Application No. 10-2024-0106892 filed on Aug. 9, 2024, in the Korean Intellectual Property Office, the entire disclosures of which are incorporated herein by reference for all purposes.

### BACKGROUND

### 1. Field of the Invention

The present disclosure relates to a training method and device for estimating depth information of an image.

### 2. Description of the Related Art

Technology for restoring a three-dimensional (3D) image based on a two-dimensional (2D) image has been studied for a long time in the field of computer vision. With the recent technological development of artificial intelligence, studies in restoring a 3D image from a 2D image by applying machine learning are actively conducted.

Restoring a 3D image requires a technique for estimating depth information (or a depth map), which is information related to the distance from a viewpoint of a 2D image to the surface of an object.

The above description has been possessed or acquired by the inventor(s) in the course of conceiving the present disclosure and is not necessarily an art publicly known before the present application is filed.

### SUMMARY

An embodiment provides technology for generating a per-pixel depth error of an image, the depth information of which is to be estimated, to train a depth information estimation model.

However, the technical goal is not limited to that described above, and other technical goals may be present.

According to an aspect, there is provided a training method for estimating depth information of an image, the training method including obtaining depth information of a first image according to a resolution based on the first image, and outputting a per-pixel depth error of the first image based on the depth information of the first image, depth information of a second image, and camera parameters. The second image and the first image may be images captured at different angles. The camera parameters may include a camera parameter of the first image and a camera parameter of the second image.

The obtaining of the depth information of the first image may include generating the depth information of the first image by processing the first image through a depth information estimation model.

The outputting of the per-pixel depth error of the first image may include verifying the depth information of the first image based on the camera parameters and the depth information of the second image.

The verifying of the depth information of the first image may include generating depth information for verification to verify the depth information of the first image by performing coordinate system transformation on the depth information of the first image based on the camera parameters and the depth information of the second image, and determining consistency of the first image based on the depth information of the first image and the depth information for verification.

The coordinate system transformation may project the depth information of the first image onto a coordinate system of the second image, project the depth information of the first image projected onto the coordinate system of the second image onto three-dimensional (3D) space based on the camera parameter of the second image, and project the depth information of the first image projected onto the 3D space onto a coordinate system of the first image again based on the camera parameter of the first image.

The determining of the consistency of the first image may include calculating a difference between the depth information of the first image and the depth information for verification, and determining the consistency of the first image pixelwise by comparing the difference between the depth information of the first image and the depth information for verification with a threshold value.

The difference between the depth information of the first image and the depth information for verification may include at least one of a pixel displacement error (PDE) and a relative depth difference (RDD) between the depth information of the first image and the depth information for verification.

The training method may further include training the depth information estimation model based on the per-pixel depth error of the first image.

According to an aspect, there is provided a training device for estimating depth information of an image, the training device including a processor, and a memory configured to store instructions. The instructions, when executed by the processor, may cause the training device to obtain depth information of a first image according to a resolution based on the first image, and output a per-pixel depth error of the first image based on the depth information of the first image, depth information of a second image, and camera parameters. The second image and the first image may be images captured at different angles. The camera parameters may include a camera parameter of the first image and a camera parameter of the second image.

The instructions, when executed by the processor, may cause the training device to generate the depth information of the first image by processing the first image through a depth information estimation model.

The instructions, when executed by the processor, may cause the training device to verify the depth information of the first image based on the camera parameters and the depth information of the second image.

The instructions, when executed by the processor, may cause the training device to generate depth information for verification to verify the depth information of the first image by performing coordinate system transformation on the depth information of the first image based on the camera parameters and the depth information of the second image. The instructions, when executed by the processor, may cause the training device to determine consistency of the first image based on the depth information of the first image and the depth information for verification.

The coordinate system transformation may project the depth information of the first image onto a coordinate system of the second image, project the depth information of the first image projected onto the coordinate system of the second image onto 3D space based on the camera parameter of the second image, and project the depth information of the first image projected onto the 3D space onto a coordinate system of the first image again based on the camera parameter of the first image.

The instructions, when executed by the processor, may cause the training device to calculate a difference between the depth information of the first image and the depth information for verification. The instructions, when executed by the processor, may cause the training device to determine the consistency of the first image pixelwise by comparing the difference between the depth information of the first image and the depth information for verification with a threshold value.

The difference between the depth information of the first image and the depth information for verification may include at least one of a PDE and an RDD between the depth information of the first image and the depth information for verification.

The instructions, when executed by the processor, may cause the training device to train the depth information estimation model based on the per-pixel depth error of the first image.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates an example of a training system of a depth estimation device according to an embodiment;

FIG. 2 illustrates an example of the depth estimation device shown in FIG. 1;

FIG. 3 illustrates an example of a training device shown in FIG. 1;

FIG. 4 is a flowchart illustrating a training method for estimating depth information according to an embodiment;

FIG. 5 is a flowchart illustrating an example of calculating a per-pixel error of an image according to an embodiment; and

FIG. 6 illustrates an example of a training device according to an embodiment.

### DETAILED DESCRIPTION

The following detailed structural or functional description is provided as an example only and various alterations and modifications may be made to the embodiments. Here, the embodiments are not construed as limited to the disclosure and should be understood to include all changes, equivalents, and replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly, the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical or scientific terms have the same meaning as commonly understood by one of ordinary skill in the art to which examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like components, and any repeated description related thereto will be omitted.

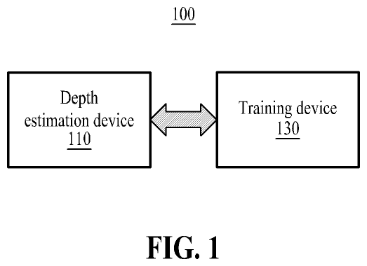

FIG. 1 illustrates an example of a training system of a depth estimation device according to an embodiment.

Referring to FIG. 1, a training system 100 may include a depth estimation device 110 and a training device 130.

The depth estimation device 110 and the training device 130 may be implemented as a single electronic device. However, embodiments are not limited thereto, the depth estimation device 110 and the training device 130 may be implemented as different electronic devices, respectively. For example, the depth estimation device 110 trained by the training device 130 may be implemented as an electronic device excluding the training device 130.

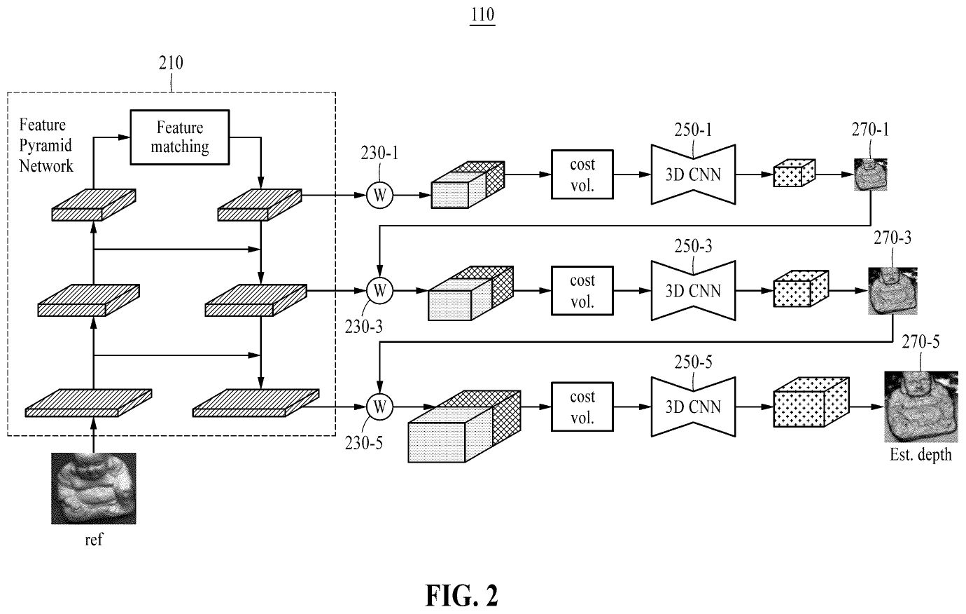

The depth estimation device 110 may estimate depth information of an image. The depth estimation device 110 may generate depth information of a first image according to a resolution by processing the first image through a depth information estimation model. The depth information estimation model may estimate depth information of an image stepwise by resolution. This will be described in detail with reference to FIG. 2.

The training device 130 may train the depth estimation device 110. The training device 130 may obtain (e.g., receive) the depth information estimated by the depth estimation device 110. The training device 130 may generate training data (e.g., a per-pixel depth error of the image) to train the depth estimation device 110 based on the depth information estimated by the depth estimation device 110.

The training device 130 may obtain the depth information of the first image according to a resolution. The training device 130 may output the per-pixel depth error of the first image based on the depth information of the first image (e.g., a reference image), depth information of a second image (e.g., a source image), and camera parameters. The second image and the first image may be images captured at different angles. The camera parameters may include a camera parameter of the first image and/or a camera parameter of the second image. The camera parameters may include an intrinsic parameter and an extrinsic parameter of a camera capturing an image (e.g., the first image and/or the second image).

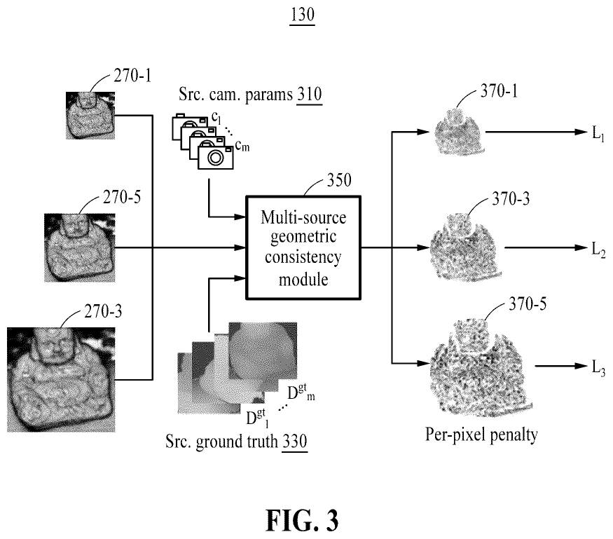

The detailed configuration and/or operation of the training device 130 will be described in detail with reference to FIG. 3.

FIG. 2 illustrates an example of the depth estimation device shown in FIG. 1.

Referring to FIG. 2, the depth estimation device 110 may include a feature pyramid network 210, one or more warping layers 230-1 to 230-5, and one or more 3D convolutional neural networks (CNNs) 250-1 to 250-5.

The feature pyramid network 210, the one or more warping layers 230-1 to 230-5, and the one or more 3D CNNs 250-1 to 250-5 may be implemented as a single depth information estimation model (not shown).

The number of warping layers 230-1 to 230-5 and the number of 3D CNNs 250-1 to 250-5 may be determined based on the number of resolutions according to which depth information of an image is to be estimated. For example, to estimate depth information of an image according to n resolutions, n warping layers and n 3D CNNs respectively corresponding to the warping layers may be needed.

Hereinafter, for ease of description, it is assumed that depth information of an image is estimated according to three resolutions (e.g., a first resolution, a second resolution, and a third resolution).

The feature pyramid network 210 may extract a feature of the first image according to a resolution based on the first image. In the case of estimating the depth information according to three resolutions, the feature pyramid network 210 may extract features of the first image according to the respective resolutions.

The warping layers 230-1 to 230-5 may generate a cost volume related to the correlation between the first image and the second image based on the features of the first image according to the respective resolutions and the second image. The warping layers may process the features of the first image by the respective resolutions, and thus, a description will be provided hereinafter based on the warping layer 230-1.

The warping layer 230-1 may generate a first cost volume according to the first resolution based on a feature of the first image according to the first resolution and the second image. For example, the warping layer 230-1 may warp a feature of the second image from the feature of the first image according to the first resolution to an image coordinate system of the first image through a homography matrix. The warping layer 230-1 may generate the first cost volume by calculating the correlation between the features of the second image warped to the image coordinate system of the first image and the features of the first image.

The warping layer 230-3 and the warping layer 230-5 may also generate a second cost volume and a third cost volume according to the second resolution and the third resolution, respectively. The operation of the warping layer 230-3 and the operation of the warping layer 230-5 are substantially the same as the operation of the warping layer 230-1, and thus, a repeated description will be omitted.

The warping layers 230-1 to 230-5 may output the generated cost volumes to the 3D CNNs 250-1 to 250-5, respectively.

The 3D CNNs 250-1 to 250-5 may generate depth information of the first image according to the respective resolutions based on the generated cost volumes. For example, the 3D CNN 250-1 may generate depth information 270-1 of the first image according to the first resolution based on the first cost volume according to the first resolution. The 3D CNN 250-3 and the 3D CNN 250-5 may also generate depth information 270-3 of the first image according to the second resolution and depth information 270-5 of the first image according to the third resolution based on the second cost volume according to the second resolution and the third cost volume according to the third resolution, respectively.

The 3D CNNs 250-1 to 250-5 may output the generated depth information 270-1 to 270-5 of the first image to the training device 130.

FIG. 3 illustrates an example of the training device shown in FIG. 1.

Referring to FIG. 3, the training device 130 may include a multi-source geometric consistency module 350.

The training device 130 may obtain the depth information 270-1 to 270-5 of the first image according to resolutions from a depth estimation device (e.g., the depth estimation device 130 of FIG. 1). As described with reference to FIG. 2, the depth information of the first image may be extracted according to various resolutions. Hereinafter, for ease of description, it is assumed that the depth information 270-1 to 270-5 of the first image is extracted according to three resolutions.

The multi-source geometric consistency module 350 may determine the geometric consistency of the first image and the second image by resolutions. The multi-source geometric consistency module 350 may generate per-pixel depth errors 370-1 to 370-5 of the first image by determining the geometric consistency between the depth information 270-1 to 270-5 of the first image by resolutions and depth information 330 of the second image.

Hereinafter, an example of generating the per-pixel depth error 370-1 for the first resolution will be described.

The multi-source geometric consistency module 350 may generate the per-pixel depth error 370-1 of the first image based on the depth information 270-1 of the first image, camera parameters 310, and the depth information 330 of the second image.

The second image and the first image may be images captured at different angles. The depth information 330 of the second image may be the ground truth (GT) value for the depth information 270-1 of the first image estimated by a depth estimation device (e.g., the depth estimation device 110 of FIG. 1), and may be information to be used to train the depth estimation device 110. A plurality of second images may be provided, and in this case, the plurality of second images may be used to verify the depth information 270-1 of the first image according to the first resolution. Hereinafter, for ease of description, it may be assumed that a single second image is provided. However, in the case where a plurality of second images are provided, it may be understood that the method for a single second image may substantially identically apply to all the second images.

The camera parameters 310 may include an intrinsic parameter and an extrinsic parameter of a camera capturing an image. The camera parameters 310 may be used to project the second image and the first image onto the same coordinate system (and/or space). For example, the camera parameter of the second image may be used to project the depth information of the first image projected onto the coordinate system of the second image onto 3D space. The camera parameter of the first image may be used to project the depth information of the first image projected onto the 3D space onto a coordinate system of the first image. This will be described in detail below through a method of performing coordinate system transformation on the depth information 710-1 of the first image.

The multi-source geometric consistency module 350 may verify the depth information 270-1 of the first image based on the camera parameters 310 and the depth information 330 of the second image. Verifying the depth information 270-1 of the first image may include determining whether the depth information 270-1 of the first image has a geometric consistency with the depth information 330 of the second image, which is a GT value.

The multi-source geometric consistency module 350 may generate depth information for verification to verify the depth information 270-1 of the first image by performing coordinate system transformation on the depth information 270-1 of the first image. The coordinate system transformation may be performed as follows. The multi-source geometric consistency module 350 may project the depth information 270-1 of the first image onto a coordinate system of the second image. The multi-source geometric consistency module 350 may project the depth information of the first image projected onto the coordinate system of the second image onto 3D space based on the camera parameter of the second image. The multi-source geometric consistency module 350 may project the depth information of the first image projected onto the 3D space onto the coordinate system of the first image again based on the camera parameter of the first image.

For example, the multi-source geometric consistency module 350 may project the depth information 270-1 of the first image onto the coordinate system of the second image by warping using a homography matrix. The multi-source geometric consistency module 350 may project the depth information of the first image projected onto the coordinate system of the second image back onto the 3D space, and reproject the depth information of the first image projected onto the 3D space onto the coordinate system of the first image again. At this time, the camera parameter of the second image may be used to project the depth information of the first image projected onto the coordinate system of the second image back onto the 3D space. The camera parameter of the first image may be used to reproject the depth information of the first image projected back onto the 3D space onto the coordinate system of the first image again.

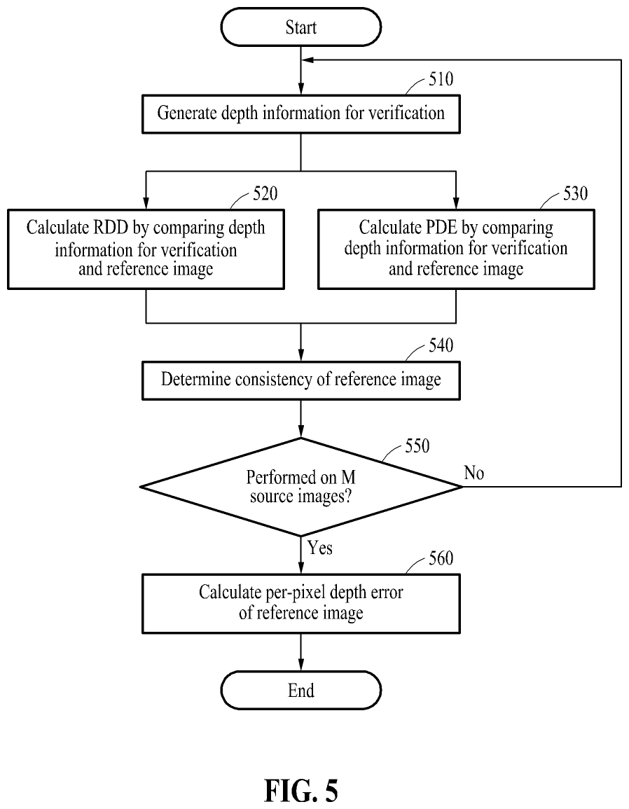

The multi-source geometric consistency module 350 may determine the consistency of the first image based on the depth information 270-1 of the first image and the depth information for verification. The multi-source geometric consistency module 350 may calculate the difference between the depth information 270-1 of the first image and the depth information for verification (e.g., the depth information of the first image on which coordinate system transformation is performed). The multi-source geometric consistency module 350 may determine the consistency of the first image pixelwise by comparing the difference between the depth information 270-1 of the first image and the depth information for verification with a threshold value. The difference between the depth information 270-1 of the first image and the depth information for verification may include at least one of a pixel displacement error (PDE) and a relative depth difference (RDD) between the depth information 270-1 of the first image and the depth information for verification. An example of calculating a per-pixel depth error of the first image by determining the consistency of the first image will be described in detail with reference to FIG. 5.

A method of generating a per-pixel depth error 370-3 and a per-pixel depth error 370-5 may be substantially the same as a method of generating the per-pixel depth error 370-1, and thus, a repeated description will be omitted.

The per-pixel depth errors 370-1 to 370-5 may be used to train a depth information estimation model (e.g., the depth estimation device 110 of FIG. 1). For example, the training device 130 may train the depth estimation device 110 based on the per-pixel depth errors 370-1 to 370-5.

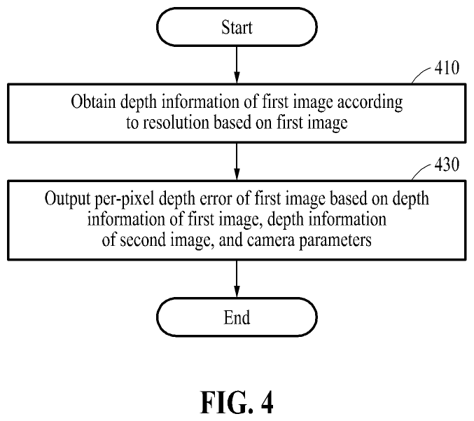

FIG. 4 is a flowchart illustrating a training method for estimating depth information according to an embodiment.

Referring to FIG. 4, operations 410 and operation 430 may be performed sequentially, but embodiments are not limited thereto. For example, two or more operations may be performed in parallel. Operation 410 and operation 430 may be substantially the same as the operation of a training device (e.g., the training device 130 of FIG. 1) described with reference to FIGS. 1 to 3. Accordingly, a repeated description will be omitted.

In operation 410, a training device (e.g., the training device 130 of FIG. 1) may obtain depth information of a first image according to a resolution based on the first image.

In operation 430, the training device 130 may output a per-pixel depth error of the first image based on the depth information of the first image, depth information of a second image, and camera parameters. The second image and the first image may be images captured at different angles. The camera parameters may include a camera parameter of the first image and/or a camera parameter of the second image. The camera parameter of the first image may include a camera intrinsic parameter and/or a camera extrinsic parameter of a camera capturing the first image. The camera parameter of the second image may include a camera intrinsic parameter and/or a camera extrinsic parameter of a camera capturing the second image.

FIG. 5 is a flowchart illustrating an example of calculating a per-pixel error of an image according to an embodiment.

Referring to FIG. 5, operations 510 to 560 may be performed sequentially, but are not necessarily performed sequentially. For example, the sequence of the operations (e.g., operations 510 to 560) may be changed, or at least two operations may be performed in parallel.

In operation 510, a training device (e.g., the training device 130 of FIG. 1) may generate depth information for verification (e.g., depth information of a first image on which coordinate system transformation is performed). An example of generating depth information for verification has been described in detail with reference to FIG. 3, and thus, the description will not be repeated below.

In operation 520, the training device 130 may calculate an RDD between the depth information for verification and depth information of a reference image (e.g., the first image) by comparing the depth information for verification and the reference image. If the depth of the reference image is accurately estimated by a depth estimation device (e.g., the depth estimation device 110 of FIG. 1), the relative depth difference between the depth information for verification and the depth information of the reference image should be “0”.

In operation 530, the training device 130 may calculate a PDE between the depth information for verification and the depth information of the reference image (e.g., the first image) by comparing the depth information for verification and the reference image. If the depth of the reference image is accurately estimated, the PDE should also be “0”, similarly to the RDD.

In operation 540, the training device 130 may determine the consistency of the reference image. For example, the training device 130 may compare the RDD and the PDE with a threshold for each pixel of the first image. The training device 130 may assign a penalty to a corresponding pixel of the image if at least one of the RDD or the PDE is greater than the threshold. The training device 130 may store the number of penalties assigned to the pixel when the penalty is assigned to the pixel of the first image.

In operation 550, the training device 130 may determine whether operations 510 to 540 have been performed on M source images (e.g., second images). If operations 510 to 540 have not been performed on the M source images, the training device 130 may perform operation 510 on a source image on which operations 510 to 540 have not been performed. If operations 510 to 540 have been performed on the M source images, the training device 130 may perform operation 560.

In operation 560, the training device 130 may calculate a per-pixel depth error of the reference image. For example, when the training device 130 determines, for the M source images, the consistency between the M source images and the reference image, a per-pixel penalty of the reference image may also be calculated M number of times in total. The training device 130 may calculate the per-pixel depth error of the reference image by dividing the number of penalties assigned to each pixel of the reference image by the total number of source images (e.g., M). The training device 130 may use, to train a depth estimation model (e.g., the depth estimation device 110 of FIG. 1), the value obtained by adding “1” to the finally calculated per-pixel depth error of the reference image for each pixel.

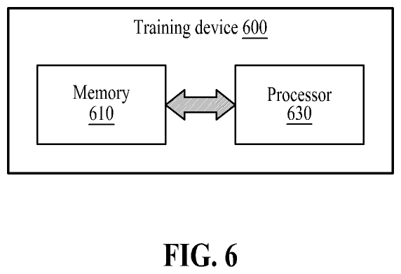

FIG. 6 illustrates an example of a training device according to an embodiment.

Referring to FIG. 6, a training device 600 may include a memory 610 and a processor 630. The training device 600 may include the training device 130 of FIG. 1.

The memory 610 may store instructions (e.g., a program) executable by the processor 630. For example, the instructions may include instructions to execute the operation of the processor 630 and/or the operation of each component of the processor 630.

The memory 610 may be implemented as a volatile memory device or a non-volatile memory device.

The volatile memory device may be implemented as dynamic random access memory (DRAM), static random access memory (SRAM), thyristor RAM (T-RAM), zero capacitor RAM (Z-RAM), or Twin Transistor RAM (TTRAM).

The non-volatile memory device may be implemented as Electrically Erasable Programmable Read-Only Memory (EEPROM), flash memory, Magnetic RAM (MRAM), Spin-Transfer Torque (STT)-MRAM, Conductive Bridging RAM (CBRAM), Ferroelectric RAM (FeRAM), Phase change RAM (PRAM), Resistive RAM (RRAM), Nanotube RRAM, Polymer RAM (PoRAM), Nano Floating Gate Memory (NFGM), holographic memory, a Molecular Electronic Memory Device, or Insulator Resistance Change Memory.

The processor 630 may process data stored in the memory 610. The processor 630 may execute computer-readable code (e.g., software) stored in the memory 610 and instructions triggered by the processor 630.

The processor 630 may be a hardware-implemented data processing device having a circuit that is physically structured to execute desired operations. For example, the desired operations may include code or instructions included in a program.

For example, the hardware-implemented data processing device may include a microprocessor, a central processing unit (CPU), a processor core, a multi-core processor, a multiprocessor, an application-specific integrated circuit (ASIC), and a field-programmable gate array (FPGA).

The processor 630 may execute the code and/or instructions stored in the memory 610 to cause the training device 600 to perform one or more operations. The operations performed by the training device 600 may be substantially the same as the operations performed by the training device 130 described with reference to FIGS. 1 to 5. Accordingly, a repeated description will be omitted.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using hardware components, software components, or a combination thereof. A processing device may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The method according to the above-described embodiments may be recorded in non-transitory computer-readable media including program instructions to implement various operations which may be performed by a computer. The media may also include, alone or in combination with the program instructions, data files, data structures, and the like. The program instructions recorded on the media may be those specially designed and constructed for the purposes of the embodiments, or they may be of the well-known kind and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as code produced by a compiler, and files containing higher level code that may be executed by the computer using an interpreter.

The described hardware devices may be configured to act as one or more software modules in order to perform the operations of the above-described embodiments, or vice versa.

Although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A training method for estimating depth information of an image, the training method comprising:
obtaining depth information of a first image according to a resolution based on the first image; and
outputting a per-pixel depth error of the first image based on the depth information of the first image, depth information of a second image, and camera parameters, wherein
the second image and the first image are images captured at different angles, and
the camera parameters comprise a camera parameter of the first image and a camera parameter of the second image.

2. The training method of claim 1, wherein the obtaining of the depth information of the first image comprises generating the depth information of the first image by processing the first image through a depth information estimation model.

3. The training method of claim 1, wherein the outputting of the per-pixel depth error of the first image comprises verifying the depth information of the first image based on the camera parameters and the depth information of the second image.

4. The training method of claim 3, wherein the verifying of the depth information of the first image comprises:
generating depth information for verification to verify the depth information of the first image by performing coordinate system transformation on the depth information of the first image based on the camera parameters and the depth information of the second image; and
determining consistency of the first image based on the depth information of the first image and the depth information for verification.

5. The training method of claim 4, wherein the coordinate system transformation
projects the depth information of the first image onto a coordinate system of the second image,
projects the depth information of the first image projected onto the coordinate system of the second image onto three-dimensional (3D) space based on the camera parameter of the second image, and
projects the depth information of the first image projected onto the 3D space onto a coordinate system of the first image again based on the camera parameter of the first image.

6. The training method of claim 4, wherein the determining of the consistency of the first image comprises:
calculating a difference between the depth information of the first image and the depth information for verification; and
determining the consistency of the first image pixelwise by comparing the difference between the depth information of the first image and the depth information for verification with a threshold value.

7. The training method of claim 6, wherein the difference between the depth information of the first image and the depth information for verification comprises at least one of a pixel displacement error (PDE) and a relative depth difference (RDD) between the depth information of the first image and the depth information for verification.

8. The training method of claim 2, further comprising:
training the depth information estimation model based on the per-pixel depth error of the first image.

9. A training device for estimating depth information of an image, the training device comprising:
a processor; and
a memory configured to store instructions, wherein
the instructions, when executed by the processor, cause the training device to:
obtain depth information of a first image according to a resolution based on the first image, and
output a per-pixel depth error of the first image based on the depth information of the first image, depth information of a second image, and camera parameters, wherein
the second image and the first image are images captured at different angles, and
the camera parameters comprise a camera parameter of the first image and a camera parameter of the second image.

10. The training device of claim 9, wherein the instructions, when executed by the processor, cause the training device to generate the depth information of the first image by processing the first image through a depth information estimation model.

11. The training device of claim 9, wherein the instructions, when executed by the processor, cause the training device to verify the depth information of the first image based on the camera parameters and the depth information of the second image.

12. The training device of claim 11, wherein the instructions, when executed by the processor, cause the training device to:
generate depth information for verification to verify the depth information of the first image by performing coordinate system transformation on the depth information of the first image based on the camera parameters and the depth information of the second image, and
determine consistency of the first image based on the depth information of the first image and the depth information for verification.

13. The training device of claim 12, wherein the coordinate system transformation
projects the depth information of the first image onto a coordinate system of the second image,
projects the depth information of the first image projected onto the coordinate system of the second image onto three-dimensional (3D) space based on the camera parameter of the second image, and
projects the depth information of the first image projected onto the 3D space onto a coordinate system of the first image again based on the camera parameter of the first image.

14. The training device of claim 12, wherein the instructions, when executed by the processor, cause the training device to:
calculate a difference between the depth information of the first image and the depth information for verification, and
determine the consistency of the first image pixelwise by comparing the difference between the depth information of the first image and the depth information for verification with a threshold value.

15. The training device of claim 14, wherein the difference between the depth information of the first image and the depth information for verification comprises at least one of a pixel displacement error (PDE) and a relative depth difference (RDD) between the depth information of the first image and the depth information for verification.

16. The training device of claim 10, wherein the instructions, when executed by the processor, cause the training device to train the depth information estimation model based on the per-pixel depth error of the first image.
